(19) United States
(12) Patent Application Publication
(10) Pub. No.: US 2004/0032394 A1
(43) Pub. Date: Feb. 19, 2004

(54) Display apparatus and display method

(76) Inventors: Yuji Ayatsuka, Tokyo (JP); Junichi Rekimoto, Tokyo (JP)

Correspondence Address: WILLIAM S. FROMMER, Esq., FROMMER LAWRENCE & HAUG LLP, 745 Fifth Avenue, New York, NY, 10151, US

(21) Appl. No.: 10/444,540

(22) Filed: May 23, 2003

(30) Foreign Application Priority Data
May 27, 2002 (JP) 2002-152884
Sep. 2, 2002 (JP) 2002-256454

(51) Int. Cl. G09G 5/00

(52) U.S. Cl. 345/156

(57) ABSTRACT

The present invention is intended to facilitate the understanding of the correlation between user operations such as loading a memory card and the displaying of a corresponding window indicative of that operation. Two slots for accommodating memory cards are arranged on one side of a display apparatus. The display apparatus is connected to a computer. When a memory card is loaded in the first slot, the applications software associated with the memory card is started up to display a window at a position approximately as high as the first slot on a display block of the display apparatus, namely at a position approximately at the same position as that of the loaded memory card which is hidden from the view of the operator. When the memory card is loaded in the second slot, another window is displayed at a position approximately corresponding to the position of the hidden memory card loaded in the second slot and hidden from the view of the operator.

### BACKGROUND OF THE INVENTION

The present invention relates generally to a display apparatus and a display method which are applied to the display apparatuses of personal computers for example.

Most personal computers are equipped with interfaces or connectors which are comparatively often attached and detached. To be more specific, desktop personal computers are equipped with a slot for accommodating memory cards and a USB (Universal Serial Bus) connector, for example. These interface and connector are located away from the monitor of each personal computer and the windows representing each memory card and a device coupled with each connector are located at positions on a monitor screen which are unilaterally determined according to software's convenience. It is also practiced with personal computers that, in infrared communication, data are transferred between a PDA and a portable personal computer (a so-called notebook-type personal computer) by approximating the PDA to the notebook-type computer).

In the conventional personal computers, the correlations between the memory cards connected to the interface, the devices connected to the USB connector, and so on and the windows on a display monitor screen of the application software which is started up when any of these memories and devices are connected is not obvious at a glance, thereby presenting problems of deteriorating the user-friendliness of personal computers. Especially, when a plurality of interfaces or connectors are used, the difficulty in understanding the above-mentioned correlation increases. In addition, in the case of infrared communication, the arrangements of the two devices involved in the communication bear no relation with the display positions on a display monitor screen of the icons for the communication, thereby presenting a problem of the difficulties in understanding the display.

### SUMMARY OF THE INVENTION

It is therefore an object of the present invention to provide a display apparatus and a display method which facilitate the understanding of the correlation between memory cards or devices connected to a personal computer and their corresponding windows on the display monitor thereof.

According to the first aspect of the present invention, there is provided a display apparatus having at least one slot for accommodating a memory card wherein, when the memory card is loaded in the slot, at least one of a window and an icon associated with the memory card is displayed in a predetermined display area which is in the proximity of the slot and in the direction of loading of the memory card.

According to the second aspect of the present invention, there is provided a display apparatus having at least one connector wherein, when a device is connected to the connector, at least one of a window or an icon associated with the device is displayed in a predetermined display area which is in the proximity of the slot and in the direction of loading of a memory card.

According to the third aspect of the present invention, there is provided a display method including the steps of:

detecting whether a memory card is loaded in a slot arranged on a display apparatus for accommodating the memory card;

acquiring information about a display position corresponding to the slot and information about application software of a type corresponding to the memory card; and

displaying at least one of the window and the icon associated with the memory card at the display position by starting up the application software.

According to the fourth aspect of the present invention, there is provided a display method including the steps of:

detecting whether a device is connected to a connector arranged on a display apparatus;

acquiring information about a display position corresponding to the connector and information about application software of a type corresponding to the device; and

displaying at least one of the window and the icon associated with the device at the display position by starting up the application software.

According to the fifth aspect of the present invention, there is provided a display apparatus having a wireless communication block based on at least one of communication media of light, sound, and radio wave wherein, when communication with another device is performed, at least one of a window and an icon associated with the communication with the another device is displayed in a display area in the proximity of the wireless communication block.

According to the sixth aspect of the present invention, there is provided a display method using a display apparatus having a wireless communication block based on at least one of communication media of light, sound, and radio wave, including the steps of:

displaying a first icon in a display area in the proximity of a the wireless communication block when starting communication with another device; and

displaying a second icon which is different from the first icon when data are actually transferred with the another device.

As described and according to the invention, when a memory card is loaded or a device is connected with a cable, the correlation between these user operations and the corresponding window and icon on the display screen is made easy to understand for the user. Especially, when a plurality of memory cards and devices are loaded and connected at the same time, the present invention facilitates the understanding of the correlation between the user operations and the corresponding windows and icons on the display screen.

As described and according to the invention, wireless communication in relatively short distances is performed with the communication block of one device directed to the communication block of the other device. In this arrangement, icons or the like are displayed at a position in the proximity of the communication block, so that the correlation between the communication operation and the displaying of icons becomes easy to understand for the user.

### BRIEF DESCRIPTION OF THE DRAWINGS

These and other objects of the invention will be seen by reference to the description, taken in connection with the accompanying drawing, in which:

FIGS. 1A and 1B are schematic diagrams illustrating a first example of a first embodiment of the invention;

FIGS. 2A and 2B are schematic diagrams illustrating a second example of the first embodiment of the invention;

FIG. 3 is a block diagram illustrating an exemplary configuration of a computer system which includes a display apparatus according to the invention;

FIG. 4 is a flowchart describing the flow of control in the display apparatus by a computer;

FIGS. 5A, 5B, and 5C are schematic diagrams illustrating an example of a display method according to the invention;

FIGS. 6A, 6B, 6C, 6D, and 6E are schematic diagrams illustrating another example of the display method according to the invention;

FIG. 7 is a schematic diagram illustrating a third example of the first embodiment of the invention;

FIGS. 8A, 8B, 8C, and 8D are schematic diagrams illustrating a fourth example, a fifth example, a sixth example, and a seventh example of the first embodiment according to the invention;

FIGS. 9A, 9B, 9C, and 9D are schematic diagrams illustrating an eighth example of the first embodiment according to the invention;

FIG. 10 is a schematic diagram illustrating a ninth example of the first embodiment according to the invention;

FIGS. 11A, 11B, 11C, 11D, and 11E are schematic diagrams illustrating examples of a sending/receiving block and its instillation positions in a second embodiment according to the invention as applied to infrared communication;

FIGS. 12A, 12B, and 12C are schematic diagrams illustrating a method of displaying icons in the second embodiment according to the invention;

FIGS. 13A and 13B are schematic diagrams illustrating a method of displaying icons in the second embodiment according to the invention;

FIGS. 14A and 14B are schematic diagrams illustrating another method of displaying icons in the second embodiment according to the invention;

FIG. 15 is a schematic diagram illustrating an example of an electronic camera in a third embodiment according to the invention as applied to an optical communication using a flash light;

FIG. 16 is a schematic diagram illustrating a method of communication in the third embodiment according to the invention;

FIG. 17 is a diagram illustrating an exemplary structure of communication data in the third embodiment according to the invention;

FIG. 18 is a block diagram illustrating an exemplary configuration of a receiving block in the third embodiment according to the invention;

FIG. 19 is a diagram illustrating an exemplary configuration of the receiving block in the third embodiment according to the invention;

FIG. 20 is a schematic diagram illustrating a method of displaying icons in the third embodiment according to the invention;

FIG. 21 is a schematic diagram illustrating a method of displaying icons in the third embodiment of the invention;

FIGS. 22A and 22B are schematic diagrams illustrating a fourth embodiment according to the invention as applied to a communication using audio signals; and

FIGS. 23A and 23B are schematic diagrams illustrating a fifth embodiment according to the invention as applied to a communication using comparatively weak radio waves.

### DETAILED DESCRIPTION OF THE PREFERRED EMBODIMENT

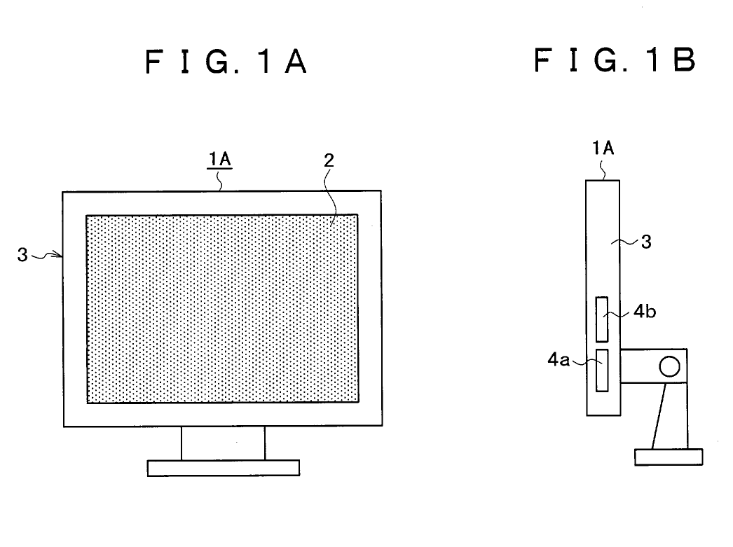

This invention will be described in further detail by way of example with reference to the accompanying drawings. Now, referring to FIG. 1, reference numeral 1A shows a first example of a display apparatus based on an LCD for example for a computer, to which the present invention is applied. The display apparatus 1A has a display block 2 and two slots 4a and 4b for accommodating memory cards on the lower portion of the main frame at a side 3. The memory cards that can be accommodated in these slots include a flash ROM for example.

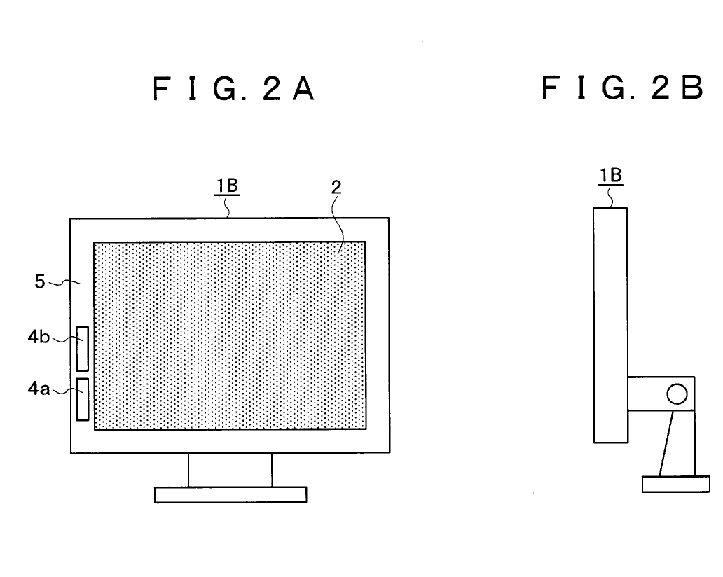

Referring to FIG. 2, reference numeral 1B shows a second example of the display apparatus for a computer, to which the present invention is applied. The display apparatus 1B has the two slots 4a and 4b on a side portion 5 of the front frame around the display block 2. Both the display apparatus 1A and the display apparatus 1B are adjustable in the tilt angle of the display block 2.

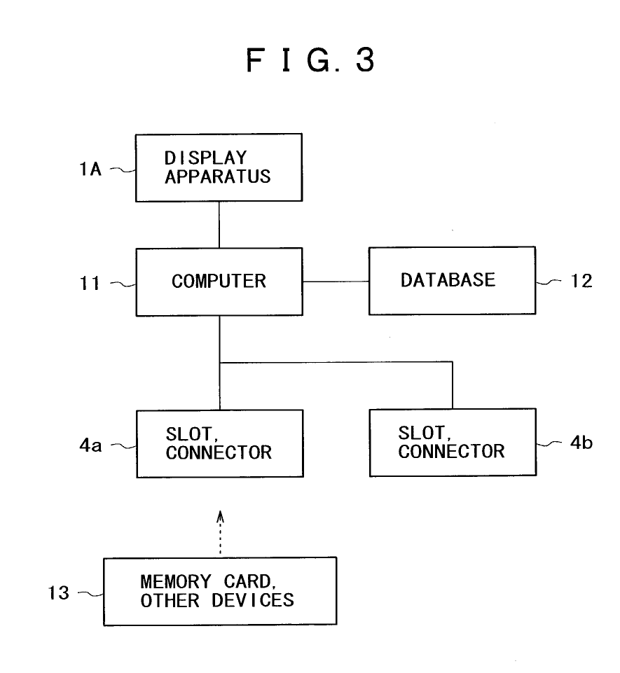

As shown in FIG. 3, the display apparatus 1A is connected to a computer 11 with a cable or in a wireless manner. The computer 11 is connected to a database 12. The memory card slots 4a and 4b are connected to the computer 11. Each of the slot 4a and the slot 4b is adapted to accommodate a memory card 13.

The positional relationships of the slots 4a and 4b relative to the display block 2 are set in advance and these settings are stored in the database 12. The database 12 also stores the information about window display methods. Further, the database 12 stores the information about the applications corresponding to the memory cards to be inserted and the devices to be connected. The application software itself is installed on the hard disk of the computer 11 beforehand.

For example, if a memory card storing the imaging data supplied from a digital camera is loaded in one of the slots, a viewer software program for viewing taken images is started up. In the case of a memory card storing a compressed file of music data, a playback software program for reproducing the music data must be started up. If a compact printer is coupled to one of the connectors, a corresponding printer driver program is started up.

It should be noted that a system configuration shown in FIG. 3 substantially holds true with the display apparatus 1B and another display apparatus which will be described later. Referring to FIG. 3, connectors may be used instead of the slots 4a and 4b. To the connectors, devices other than memory cards are coupled.

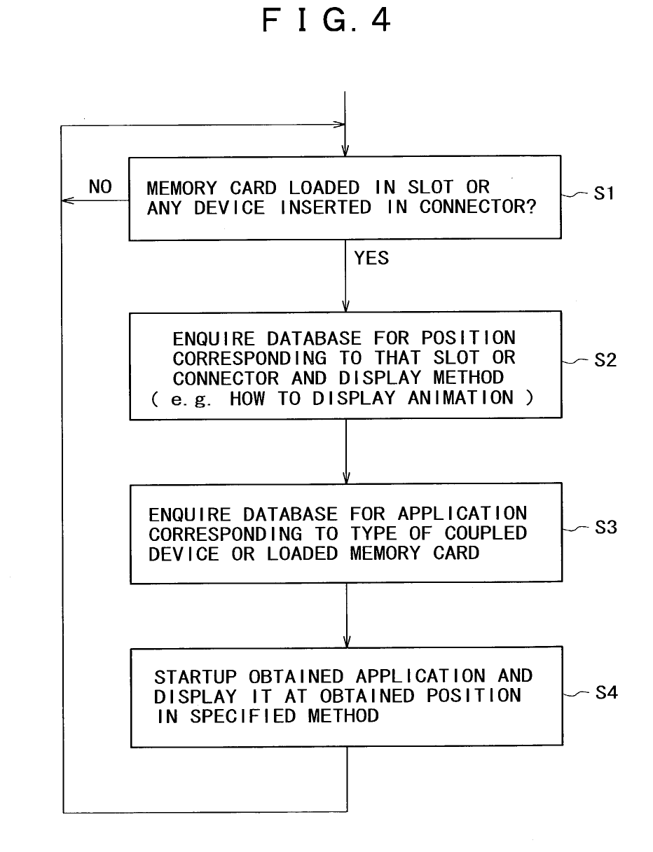

Referring to FIG. 4, there is shown a flowchart describing a flow of operations to be performed under the control of the computer 11 when a memory card is loaded in the slot 4a or 4b or a device is coupled to one of the connectors. In step S1, the computer 11 determines whether or not a memory card has been loaded in one of the slots or a device has been coupled to one of the connectors. This decision step S1 is repeated until a memory card is loaded or a device is coupled.

If a memory card is found loaded or a device is found coupled, then the computer 11 enquires the database 12 for the positional information about the slot concerned or the connector concerned and a display method in step S2. In step S3, the computer 11 enquires the database 12 for an application software program which corresponds to the loaded memory card or the coupled device.

In step S4, on the basis of the information retrieved from the database 12, the application is started up and a corresponding window is displayed on the display block 2 of the display apparatus 1A at a specified position in a specified method. Then, back in step S1, the computer 11 gets in the state in which the computer 11 determines whether a memory card has been loaded or a device has been coupled.

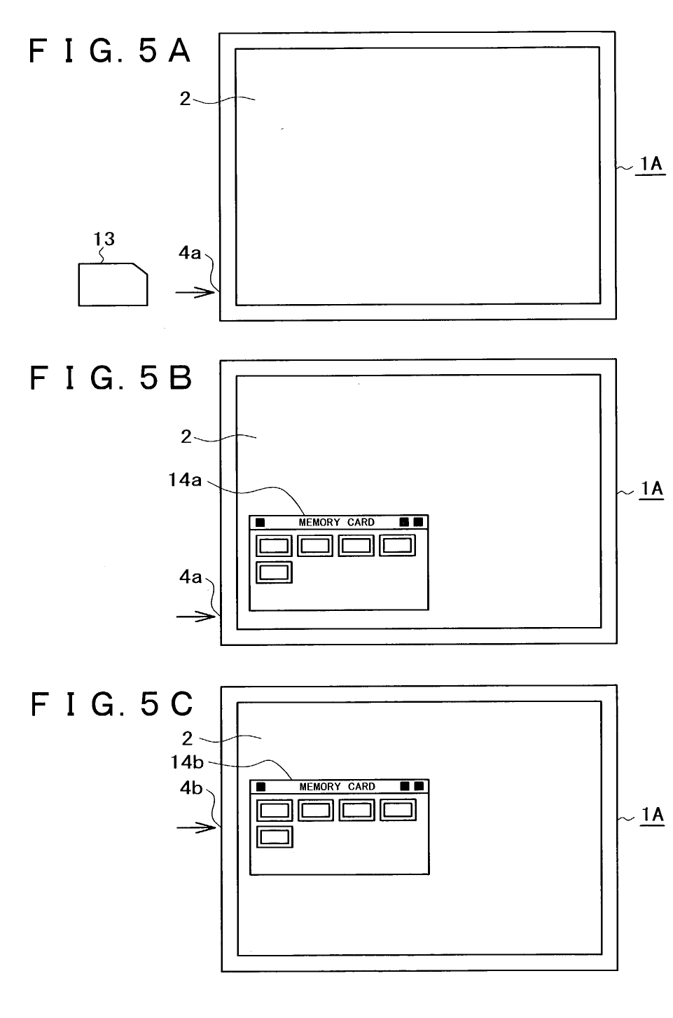

The following describes a method of displaying windows by use of display apparatus 1A for example. Referring to FIGS. 5A, 5B, and 5C, there is shown a first display method. As shown in FIG. 5A, the memory card 13 is loaded in the slot 4a of the display apparatus 1A. Next, the application software program associated with the memory card 13 is started up and then a window 14a is displayed at a position approximately as high as the slot 4a of the display apparatus 1A, namely, at the approximately same position of the loaded memory card 13 which is hidden from the view of the operator. For example, in the window 14a, the thumbnails representing the still images stored in the memory card 13 are displayed. When a desired thumbnail is selected by operating the mouse for example, the still image represented by the selected thumbnail will be displayed.

As shown in FIG. 5C, if the memory card 13 is loaded in the slot 4b, then a window 14b is displayed at approximately the same position as the memory card 13 loaded in the slot 4b and hidden from the view of the operator. Although not shown, if the memory cards are loaded in both the slots 4a and 4b, the two corresponding windows 14a and 14b are displayed in the display block 2 of the display apparatus 1A.

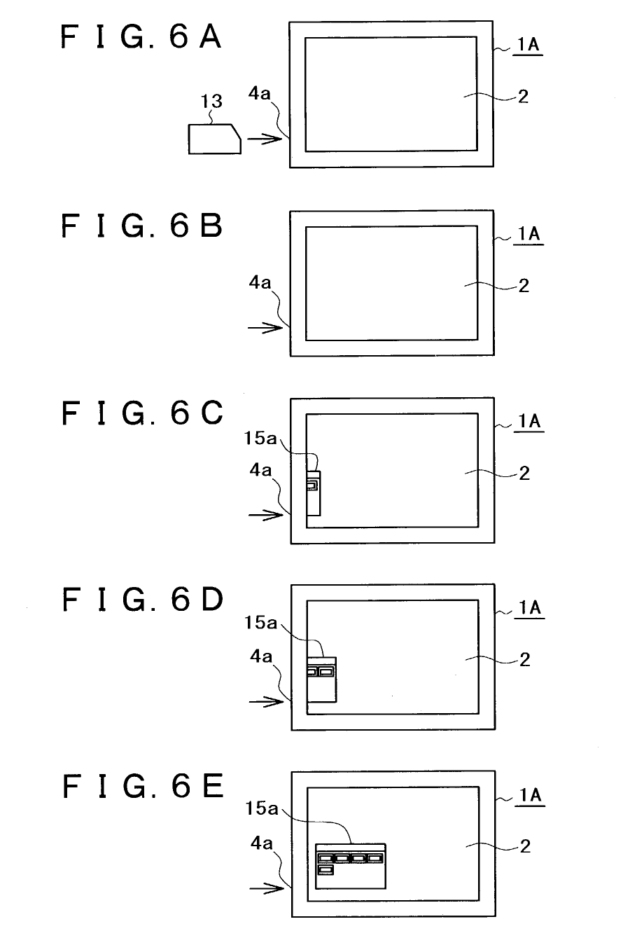

Referring to FIGS. 6A, 6B, 6C, 6D, and 6E, there is shown another display method. As shown in FIG. 6A, the memory card 13 is loaded in slot 4a of the display apparatus 1A. Next, the application software program associated with the memory card 13 is started up. Immediately after the loading of the memory card 13, no window display is performed as shown in FIG. 6B.

Next, as shown in FIG. 6C, a part of a window 15a is displayed at approximately the a position as high as the slot 4a of the display block 2 of the display apparatus 1A, namely, the loaded memory card 13 which is hidden from the view of the operator. Then, as if the memory card were being loaded, the rest of the window 15a gradually appears as shown in FIG. 6D, finally fully appearing as shown in FIG. 6E. Namely, in the method shown in FIGS. 6, the window representing the contents of the memory card is displayed in animation in which the memory card being loaded is displayed as it is, thereby providing better user-friendliness.

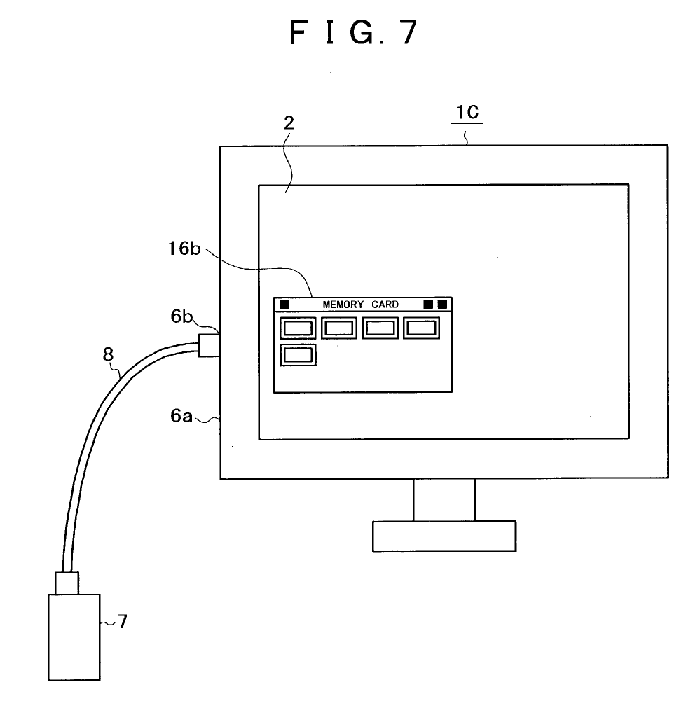

The following describes several variations to this embodiment according to the invention. Referring to FIG. 7, reference numeral 1C denotes a third example of the display apparatus according to the invention. The display apparatus 1C has a connector 6a and a connector 6b on one side of its main frame. Each of the connectors 6a and 6b is based on one of the standards such as USB (Universal Serial Bus), IEEE (Institute of Electrical and Electronics Engineers) 1394 and so on. To each of the connectors 6a and 6b, a device such as a memory card reader 7 is coupled via a cable 8.

When the memory card reader 7 is coupled to the connector 6bfor example, the corresponding application program is started up as with the above-mentioned operation to be performed when the memory card is loaded in one of the slot and a window 16b indicative of the contents of the loaded memory card is displayed on the screen at a position approximately as high as the installation position of the connector 6b.

If a device which can be handled as a storage device other than the memory card reader 7 is coupled to the display apparatus 1C via USB or IEEE 1394 for example, the corresponding window may be displayed upon coupling. To be more specific, the present invention is applicable to the connection of CD-ROM drive, hard disk drive, digital camera, mobile telephone, PDA (Personal Digital Assistants), and so on.

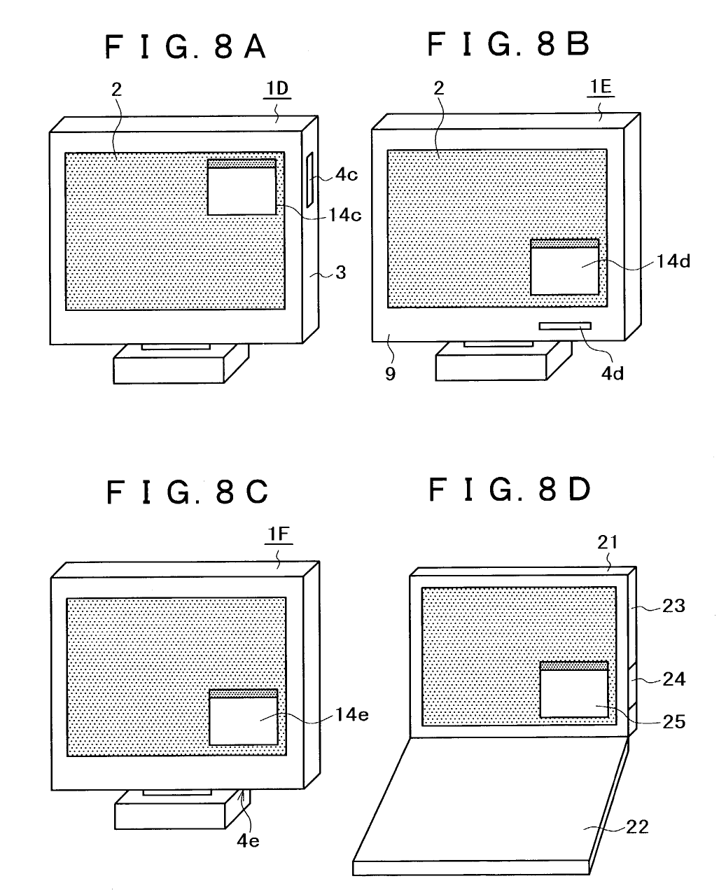

A display device 1D shown in FIG. 8A is a fourth example, in which a slot 4c is arranged in the upper portion of one side, a side C. When a memory card is loaded in the slot 4c, a window 14c is displayed in an area on the screen at the position which is approximately the same as the position of the loaded memory card which is hidden from the view of the operator. A display apparatus 1E shown in FIG. 8B shows a fifth example in which a slot 4d is arranged on a lower portion 9 of the frame of the display block 2. When a memory card is loaded in the slot 4d, a window 14d is displayed in an area at the lower portion of the screen of display block 2 and over the slot 4d. A display apparatus 1F shown in FIG. 8C shows a sixth example in which a slot 4e is arranged on the bottom of the display block 2. When a memory card is loaded in the slot 4e, a window 14e is displayed in an area at approximately the same position as the loaded memory card which is hidden from the view of the operator.

An example shown in FIG. 8D denotes a seventh example in which the present invention is applied to a portable personal computer. A flat display block 21 such as a liquid crystal display is pivotally installed on a main frame 22. The main frame 22 has a keyboard and so on, not shown. A slot 24 is arranged on a side 23 of the display block 21. When a memory card is loaded in the slot 24, a window is displayed at display position 25 which is almost as high as the slot 24 and corresponds to the position of the loaded memory card which is hidden from the view of the operator. It should be noted that, in each of the examples shown in FIGS. 8A through 8D, the method for displaying animation described with reference to FIG. 6 may be used. Moreover, connectors may be used instead of the slots in this example.

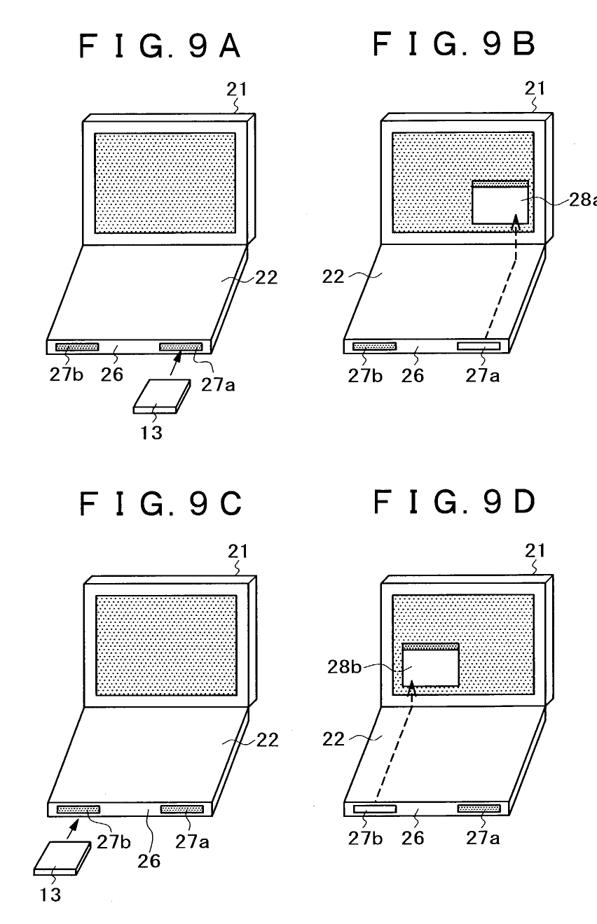

Referring to FIGS. 9A, 9B, 9C, and 9D, there is shown an eighth example in which the present invention is applied to a portable personal computer. In the example shown in these figures, two slots 27a and 27b are arranged on a front side 26 of a main frame 22. As shown on FIG. 9A, when the memory card 13 is loaded in the 27a, a window 28a is displayed in a display area on the display block 21 located in the direction of loading the memory card 13 into the slot 27a as shown in FIG. 9B.

As shown in FIG. 9C, when the memory card 13 is loaded in the other slot 27b, a window 28b is displayed in a display area of the display block 21 in the direction of the loading of the memory card 13 as shown in FIG. 9D. In the example shown in FIGS. 9A through 9D, the installation positions of the slots 27a and 27b may be correlated with the positions of the corresponding windows even if the slots 27a and 27b are slightly separated away from the screen of the display block 21. It should be noted that, in the example shown in FIGS. 9A through 9D, the method of displaying animation described with reference to FIG. 6 may be applied. In addition, connectors-may be used instead of the slots in this example.

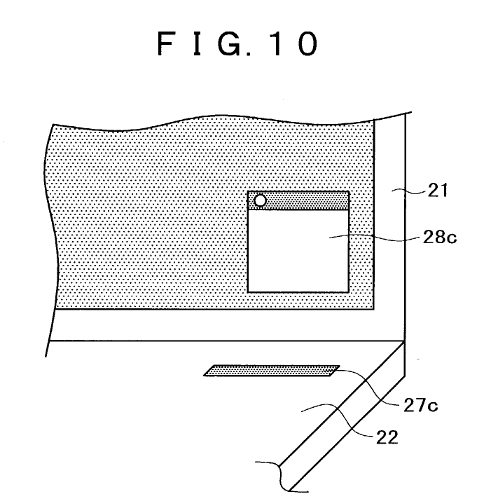

Referring to FIG. 10, there is shown a ninth example in which the present invention is applied to a portable personal computer. In this example, a slot 27c is installed at a position in the proximity of a display block 21 relative to a computer main frame 22; for example, in the upper right corner of a main frame 22, as viewed from top. When a memory card is loaded in the slot 27c in a tilted manner, a window 28c is displayed in a display area of the lower right corner of the display screen of the display block 21. It should be noted that, in the example shown in FIG. 10, the method of displaying animation described with reference to FIG. 6 may be applied. In addition, a connector may be used instead of the slot in this example.

It should also be noted that a corresponding icon may be displayed instead of the window on the screen when a memory card is loaded in the slot or a device is connected to the connector. Further, the configuration of the main frame of the personal computer may be assembled in the display apparatus itself.

The following describes another embodiment of the present invention in which the present invention is applied to wireless communication based on optical, sound, or radio wave medium; for example, infrared communication. For an optical communication format, e.g. an infrared communication format, one determined by IrDA (Infrared Data Association) is in use. Recently, image communication standard “IrTran-P” based on infrared communication has been approved as an international standard. IrTran-P supports the transfer of still images taken by digital cameras by means of infrared communication. In addition, the IrBus standard which is a new bidirectional infrared communication standard has also been proposed. Today, many portable personal computers and PDAs have an infrared communication port and infrared communication adaptors have been developed for desktop personal computers. Further, infrared communication is finding its increasing application in the field of electronic devices which handles digital data, such as mobile telephones and electronic still cameras.

In the case of the infrared communication based on the above-mentioned IrDA standard, the transmission distance is 0 to 1 meter normally. For example, the schedule data of a PDA are transmitted to a personal computer in order to obtain integrated schedule data. Conversely, data stored in a personal computer are transmitted to a PDA in an infrared communication manner.

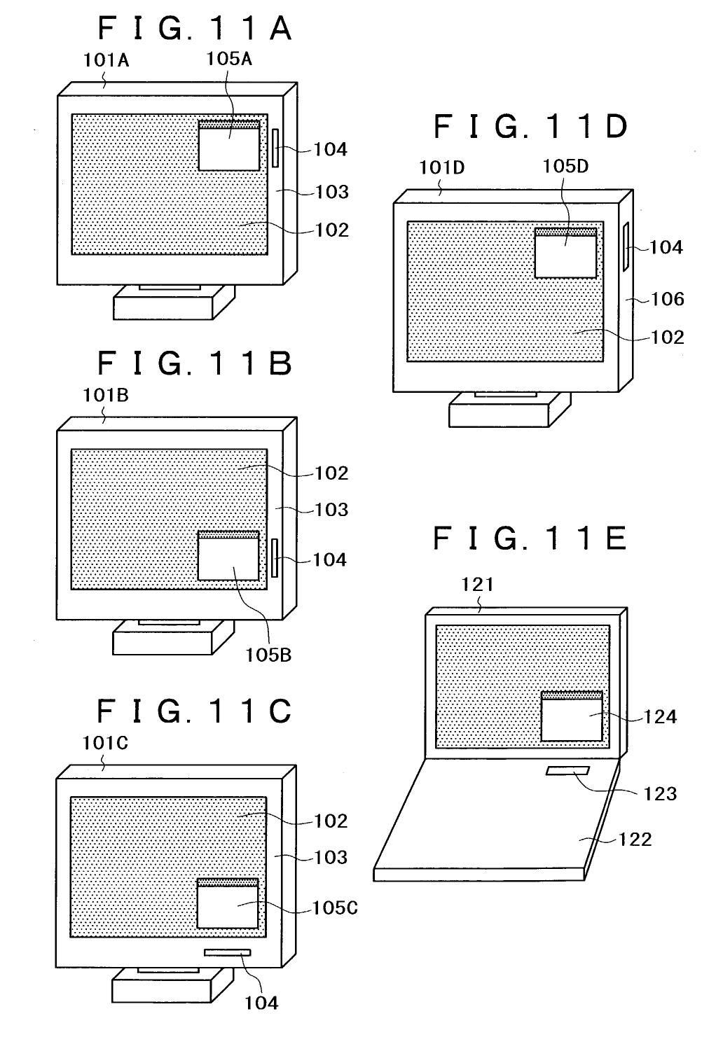

Referring to FIGS. 11A through 11E, there is shown a second embodiment in which the present invention is applied to an LCD display apparatus of a desktop personal computer having an infrared communication send/receive block. In FIG. 11A, reference numeral 101A denotes a first example of an LCD computer display apparatus for example to which the present invention is applied. The display apparatus 101A has a display block 102. In this example, an infrared communication send/receive block 104 is arranged at the upper right side of a frame 103 around the display block 102.

The display apparatus 101A is connected to the computer main frame (not shown) with a cable or in a wireless manner, thereby transferring not only the signals for display but also the data to be received from the send/receive block 104 and the data to be transmitted to the send/receive block 104. As with the configuration shown in FIG. 3 of the above-mentioned one embodiment, a database connected to the computer main frame stores beforehand the installation position of the send/receive block 104 relative to the position on the screen of the display block 102 as well as the information about a method of displaying icons or the like in the display area. The communication software for infrared communication is installed on the hard disk of the main frame of the computer in advance. The processing of received data and the preparation of data to be sent are performed on the computer main frame.

On the computer main frame, a display area 105A is arranged in the upper right corner in the proximity of the position at which the send/receive block is arranged. The display area 105A shows an icon indicative of a device in communication, an icon indicative of send/receive data, and so on. It is also practicable for the display area 105A to show windows instead of icons.

The position at which the send/receive block 104 is installed is not limited to the example shown in FIG. 11A. In the case of a display apparatus 101B shown in FIG. 11B, the infrared communication send/receive block 104 is arranged in the lower portion of the right side of the frame 103 around the display block 102. Therefore, a display block 105B for displaying an icon or the like is arranged in the lower portion of the right side of the display block 102.

In the case of a display apparatus 101C shown in FIG. 1C, the infrared communication send/receive block 104 is arranged on the right corner of the lower portion of the frame 103 around the display block 102. Therefore, a display area 105C for displaying an icon or the like is arranged in the right corner of the lower portion of the display block 102. In the case of a display apparatus 101D shown in FIG. 11D, the infrared communication send/receive block 104 is arranged in the upper portion of the right side 106 of the frame 103 around the display block 102. Therefore, a display area 105D for displaying an icon or the like is arranged in the upper right corner of the display block 102. Obviously, the send/receive block 104 may be arranged in the lower portion of the right side 106 to show the display area in the lower right corner.

The examples shown in FIGS. 11A through 11D are the display apparatuses 101A through 101D which are connected to a desktop personal computer. FIG. 11E shows an example in which a portable personal computer (a so-called notebook-type personal computer) is used. A display block 121 which is flat like LCD is pivotally mounted to a main frame 122. The main frame 122 has a keyboard and so on, not shown. An infrared communication send/receive block 123 is arranged at a position in the proximity of the joint between the main frame 122 and the display block 121.

A display area 124 for displaying an icon or the like is arranged in the display block 121 in the proximity of the position of the send/receive block 123. A database in the main frame 122 stores beforehand the information about the position at which the send/receive block 123 is installed with reference to the position on the screen of the display block 121 and the information about the method of displaying a window. The software for infrared communication is instaled on the hard disk of the main frame. It should be noted that the send/receive block may be arranged on the frame around the display block 121 or on its side.

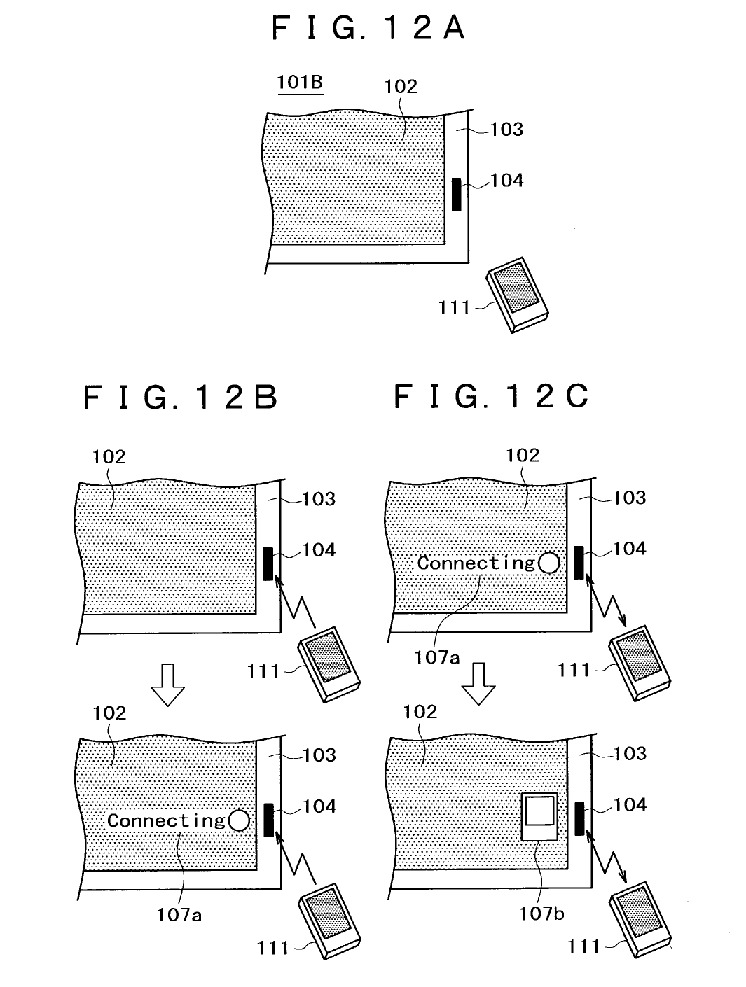

The following describes one example of a method of displaying an icon or the like with reference to FIG. 12. As shown in FIG. 12A, an operation in which data are transferred from a device having an infrared communication send/receive block, such as a PDA 111, to the display apparatus of a personal computer is described below. For this display apparatus, a display apparatus 101B is used in which the send/receive block 104 is arranged at a lower right position of the display block 102 and the display area 105B for displaying an icon or the like is arranged in the lower right corner of the display block 102, as shown in FIG. 11B. Obviously, another apparatus shown in FIGS. 11A through 11D may be used or the portable personal computer shown in FIG. 11E may be used.

The following describes the above-mentioned method along the flow of communication processing. As shown in FIG. 12B, first, the PDA 111 transmits the data indicating the start of infrared communication to the send/receive block 104 of the display apparatus. Upon detection of the carrier of the send signal supplied from the PDA 111, the personal computer detects the PDA 111, upon which an icon 107a (in the example shown, a character string “Connecting” and a white circle) indicative of a request for communication start is shown in the display block 105B.

Next, the connection is actually established to start communication, thereby showing a device icon 107b in the display area 105B as shown in FIG. 12C when the type and format for example of the device (PDA 111) are known.

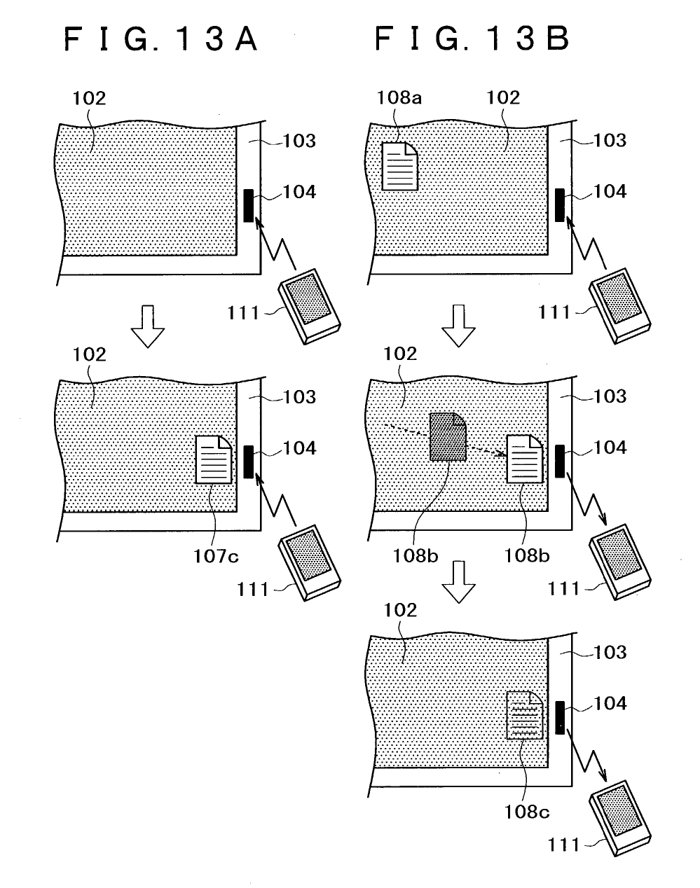

As shown in FIG. 13A, file data are transmitted from the PDA 111 to the personal computer as infrared send data, which are received at the send/receive block 104, the file data being received by the personal computer. Upon completion of the file transfer, it is shown as the icon 107c on the display area 105B.

It is also practicable to transfer data from the personal computer to the PDA 111. As shown in FIG. 13B, first, a request for file transfer is sent from the PDA 111 to the personal computer. Upon reception of this request, the personal computer displays an icon 108a indicative of a file to be transferred at a position which is separated away from the display area 105B on the display block 102.

Next, the file data are transferred from the send/receive block 104 of the personal computer as an infrared signal, which is received by the PDA 111. This file transfer is executed at a predetermined data rate. The progress of a file transfer operation is shown with an icon 108b which moves on the display block 102. When the file transfer is completed, the icon 108b disappears from the display area 105B. Reference numeral 108c denotes that the icon 108b disappeared upon completion of the file transfer. It should be noted that a file transfer operation may be executed after the user moves the icon 108b by dragging it.

When the communication discontinued halfway in a file transfer operation, an icon 107b (refer to FIG. 12C) indicative of the PDA 111 may be turned off immediately or after a predetermined extension time. During this exertion period, the icon may be put in a state in which it is half disappeared (by turning the icon translucent for example). These icon displaying manners are practiced to provide a visual effect as if the data were coming or going through the send/receive block 104.

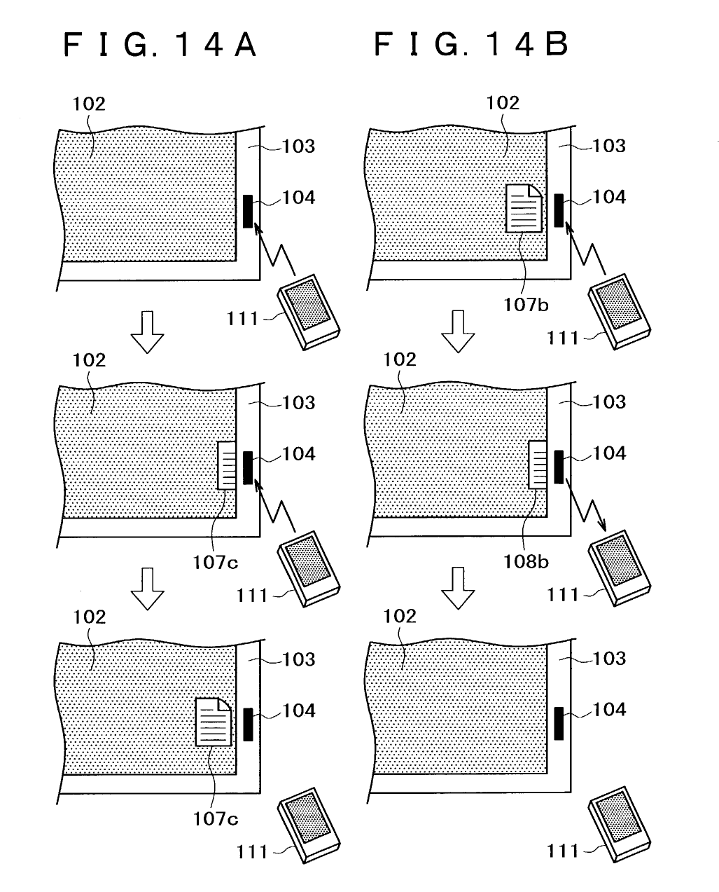

As shown in FIG. 13A, in transferring files from the PDA 111 to the personal computer, the icon 107c may be displayed in animation. FIG. 14A shows an example in which files are transferred from the PDA 111 to the personal computer. In transferring a file from the PDA 111, as the amount of the transferred data increases, the icon 107c may be moved gradually leftward from the right side of the frame 103. The icon 107c changes from the state in which it is not shown to the state in which it is fully shown upon completion of the transfer.

As shown in FIG. 13B, in transferring files from the PDA 111 to the personal computer, the icon 108b may be displayed in animation instead of turning off at the completion of the transfer. FIG. 14B shows an example in which file transfer from the personal computer to the PDA 111 is displayed in animation. When the file transfer is completed, the icon 108b gradually moves to the right, eventually disappearing from the display block 102.

It should be noted that only a part of the icon displaying methods shown in FIG. 12 and FIG. 13 (or FIG. 14) may be used. It should be noted that the present invention may be applied also to single-direction infrared communication, in addition to the bidirectional communication. Further, the present invention may also be applied to the infrared communication of electronic devices such as mobile telephones and television receivers other than personal computers.

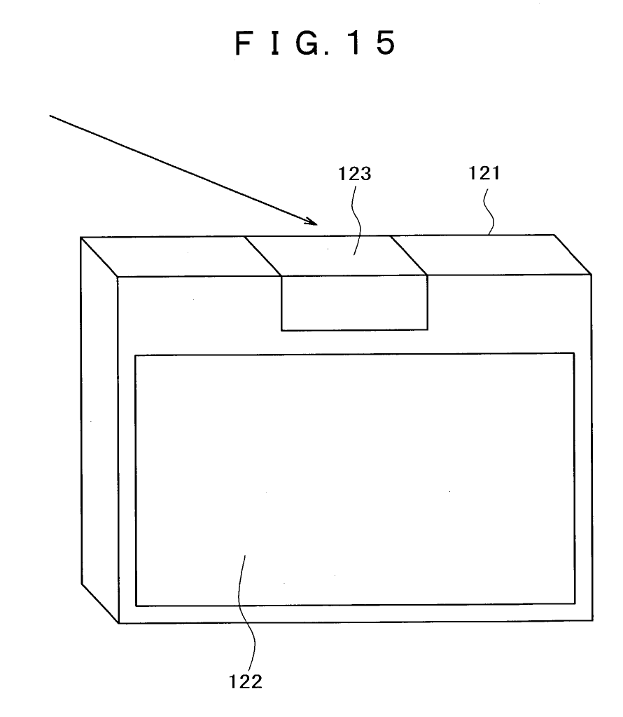

The following describes an embodiment of the invention in which present invention is applied to a communication method of sending and receiving data represented by blinking light with reference to FIG. 15. In FIG. 15, reference numeral 121 denotes a portable electronic device, an electronic camera for example. It should be noted that this portable electronic device may be a PDA, a portable movie camera, a mobile telephone, or the like.

The electronic camera 121 takes still images for example and stores the taken still images in a detachable memory card and has a small-sized LCD display 122 which functions as a camera finder and a monitor screen. The main body of the electronic camera 121 has also operator buttons such as a shutter button, not shown.

The electronic camera 121 generally has the camera block on the other side of the LCD display 122, and is adapted to take an image of an object in the direction indicated by the arrow. Separate from the camera block for imaging normal objects, a receiving block 123 for receiving data represented by blinking light is provided. The receiving block 123 is arranged at a position in the proximity of the top center of the LCD display 122.

It should be noted that the camera block for imaging normal objects and the receiving block may share a common imaging element. Further, for bidirectional communication, it may be configured that the electronic camera 121 displays a light source on the LCD display 122 in accordance with transmitted data or has a blinking light source such as an infrared emitting LED (Liquid Crystal Display) separate from the LCD display 122.

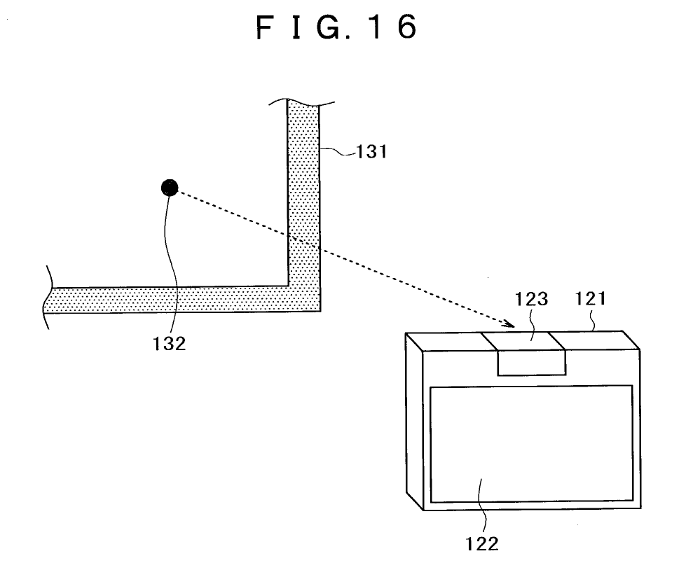

Referring to FIG. 16, there is shown a state in which a blinking image 132 displayed on a display apparatus 131 of a personal computer for example is imaged by the camera block 123 of the electronic camera 121. The blinking image is shown in the periphery of the display apparatus; for example, the lower right corner. The blinking image 132 is blinked by the software digital data to be transmitted.

The camera block 123 of the electronic camera 121 takes this blinking image 132. The transmission data can be decoded by the taken signal. For example, a desired image file is transferred from the personal computer to the electronic camera 121.

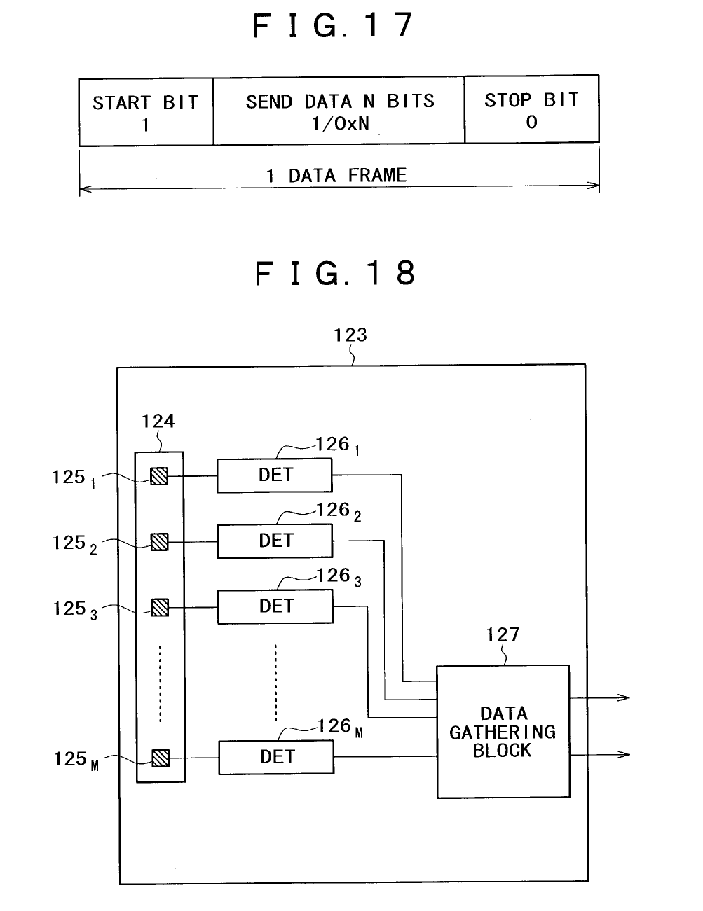

Referring to FIG. 17, there is shown a data frame structure which is sent as a blinking pattern of the blinking image 132. One data frame has a structure in which N-bit send data (payload) are placed between bit “1” start bit and bit “0” stop bit. For example, bit “0” corresponds to the “off” state of the blinking image 132 and bit “1” corresponds to “on” state of the blinking image 132.

The following details a digital communication system including the receiving block 123 of the electronic camera 121 and the blinking image 132 displayed on the display apparatus 131. As shown in FIG. 18, the receiving block 123 includes a photo receiving block 124 composed of photo receiving elements 125₁, 125₂, 125₃, . . . , 125_{M}. To the photo receiving surface of the photo receiving block 124, a blinking light generated by the display apparatus 131 through a condenser system based on condenser lens, not shown, for example is emitted.

The photo receiving block 124 is constituted by a CMOS (Complementary Metal Oxide Semiconductor) image sensor for example. The CMOS image sensor is generally faster in operation speed than the CCD (Charge Coupled Device) image sensor, so that blinking patterns may be read if the light source is blinked at high frequencies.

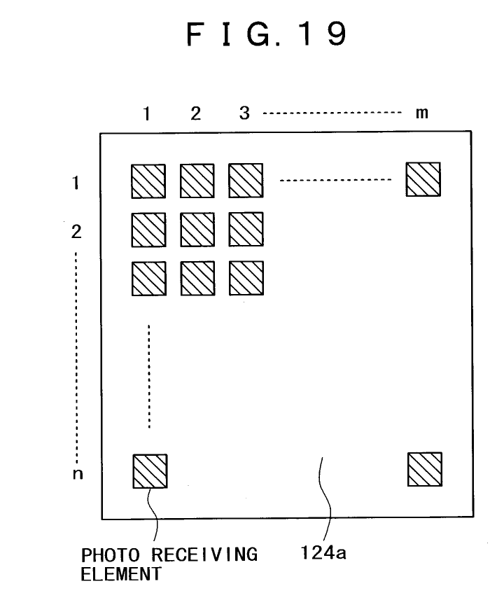

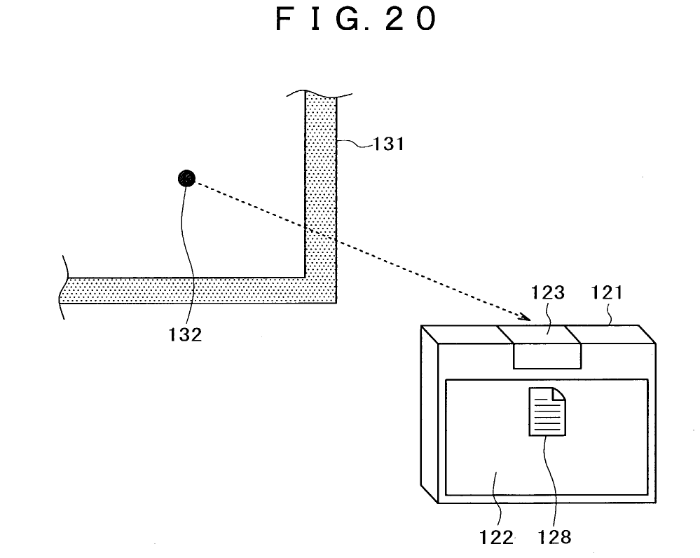

As shown in FIG. 19, a photo receiving surface 124a of the photo receiving block 124 has a configuration in which photo receiving elements are arranged in a two-dimensional matrix (n×m=M). One photo receiving element corresponds to one pixel.

As shown in FIG. 18, detection blocks 126, through 126_{M} are connected to photo receiving elements 125₁, through 125_{M} respectively. The detection blocks 126₁, through 126_{M} detect the blinking signals detected by the photo receiving elements. The detection blocks 126₁, through 126_{M} have each a bandpass filter which passes on the carrier frequency component of transmission data, a PLL, an A/D converter, an imaged data storage memory, a binarized data memory, and a received data storage memory.

The output signals of the detection blocks 126₁, through 126_{M} are supplied to a data gathering block 127. The data gathering block 127 processes the supplied output signals in an integrated manner. It also processes the blinking signals. From the data gathering block 127, the received data are outputted as a result of the blinking signal processing.

If the received data are N bits long, T-bit digital data obtained by A/D converting the output of the bandpass filter is binarized by threshold processing, the binarized data being temporarily stored in the data memory. The binarized data indicate whether the photo receiving element concerned has received an optical signal.

If the photo receiving element has received an optical signal from the display apparatus 131, the photo receiving element is exposed for a certain time in accordance with the sampling frequency after waiting for a certain time in accordance with the carrier frequency. Then, an analog signal in accordance with the exposure is A/D converted through the bandpass filter, resultant T-bit digital data being temporarily stored in the image data storage memory. Next, the T-bit digital data are binarized by threshold processing and the resultant binarized data are stored at predetermined bit positions in the received data storage memory (N bits). Then, the memory address is incremented to repeat the above-mentioned operation, thereby storing N-bit received data.

The data gathering block 127 reads the N-bit received data from each of (n×m=M) detection blocks, checks the received data for an error, and stores the checked data into the received data storage memory. The N-bit data are stored so that the value of the received data is paired with the address of the photo receiving element which outputted the received data. For each of the photo receiving elements, with respect to the photo receiving elements which received valid data, the received data are stored in a pair with the information (address) about the photo receiving element position. Therefore, the output read from the data gathering block 127 is also a pair of N-bit data and address information.

If the photo receiving block 124 of the receiving block 123 is not dedicated for communication but functions also as the imaging block for taking scenes as a camera, the imaging operation mode (called the image mode) and the operation mode (called the decode mode) for receiving and processing the optical signal from the display apparatus 131 are set alternately.

When the receiving block 123 takes the blinking image 132 of the display apparatus 131 of the personal computer, the data from the personal computer may be received by the electronic camera 121. As shown in FIG. 20, when the electronic camera 121 receives the data, an icon 128 indicative that the data have been received in an area in the proximity of the receiving block 123 on the LCD display 122.

It should be noted that the icon 128 may also be displayed in moving or in animation as described above. In addition, different icons may be used for a state in which the connection is established and a state in which data are actually transmitted.

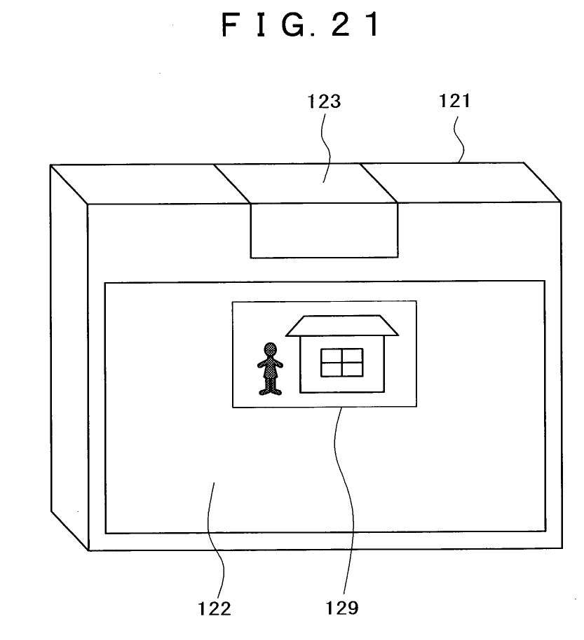

Further, as shown in FIG. 21, the taken image 129 may be displayed at a position in the proximity of the receiving block 123. This has nothing to do with the above-mentioned communication, but is intended to indicate that the taken image 129 has a meaning which is different from that of other taken images. For example, the most recent taken image is displayed in an area in the proximity of this receiving block 123. Consequently, if other taken images are displayed on the screen, the user can easily recognize the most recent taken image.

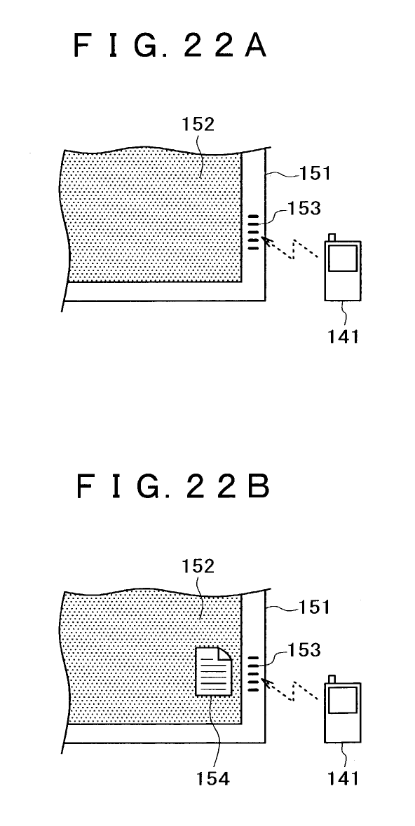

The present invention is not limited to optical applications; for example, present invention is also applicable to the communication based on audio signals. FIGS. 22A and 22B illustrate an example in which an audio signal, a DTMF (Dual Tone Multi-Frequency) signal for example, is transmitted from a portable electronic device, a mobile telephone 141 for example, to an audio signal receiving block 153 arranged on a lower right portion of the frame of a display apparatus 151 of a personal computer. When data are transmitted from the mobile telephone 141, an icon 154 is displayed in an area in the proximity of the audio signal receiving block 153 in a display block 152 of the display apparatus 151.

It should be noted that the icon 154 may be displayed in moving or in animation as described above. Different icons may be used for a state in which the connection is established and a state in which data are actually transmitted.

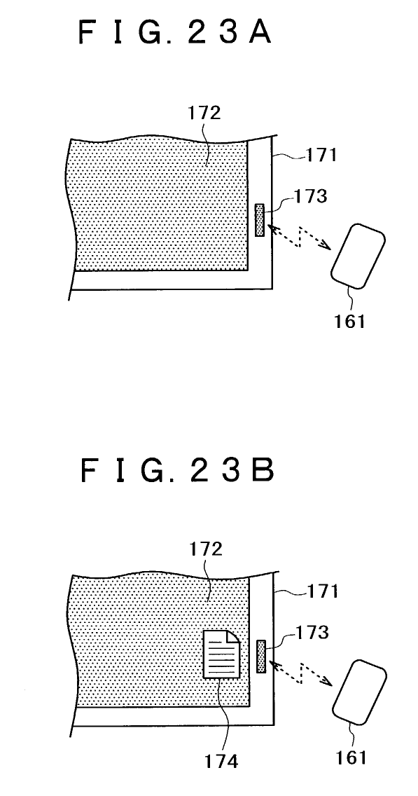

Moreover, the present invention is also applicable to the wireless communication which uses comparatively weak radio waves for the communication at proximity distances. FIGS. 23A and 23B illustrate an example of the wireless communication. In these figures, reference numeral 161 denotes a noncontact-type IC card. The IC card 161 is brought toward an antenna block 173 arranged at a lower right portion of the frame of a display apparatus 171 of a personal computer for communication.

The data stored in the IC card 161 are read by the antenna block 173 and transferred to the personal computer. When the data transfer has been completed, an icon 174 indicative of the completion of data transfer is displayed in an area at a position in the proximity of the antenna block 173 of the display block 172 as shown in FIG. 23B.

It should be noted that the icon 174 may be displayed in moving or animation as described above. Different icons may be used for a state in which the connection is established and a state in which data are actually transmitted.

While the preferred embodiments of the present invention have been described using specific terms, such description is for illustrative purposes only, and it is to be understood that changes and variations may be made without departing from the spirit or scope of the appended claims.

What is claimed is:

1. A display apparatus having at least one slot for accommodating a memory card wherein, when the memory card is loaded in said slot, at least one of a window and an icon associated with said memory card is displayed in a predetermined display area which is in the proximity of said slot and in the direction of loading of said memory card.

2. The display apparatus according to claim 1 wherein, when at least one of said window and said icon is displayed, at least one of said window and said icon is gradually displayed and/or contents of said memory card are displayed in said window.

3. A display apparatus having at least one connector wherein, when a device is connected to said connector, at least one of a window or an icon associated with said device is displayed in a predetermined display area which is in the proximity of said slot and in the direction of loading of a memory card.

4. The display apparatus according to claim 3 wherein, when at least one of said window and said icon is displayed, at least one of said window and said icon is gradually displayed.

5. The display apparatus according to claim 3, said display apparatus being at least in one of states in which said display apparatus is physically separated from a computer and said display apparatus is coupled with a main body of said computer.

6. A display method comprising the steps of:
detecting whether a memory card is loaded in a slot arranged on a display apparatus for accommodating said memory card;
acquiring information about a display position corresponding to said slot and information about application software of a type corresponding to said memory card; and
displaying at least one of said window and said icon associated with said memory card at said display position by starting up said application software.

7. A display method comprising the steps of:
detecting whether a device is connected to a connector arranged on a display apparatus;
acquiring information about a display position corresponding to said connector and information about application software of a type corresponding to said device; and
displaying at least one of said window and said icon associated with said device at said display position by starting up said application software.

8. A display apparatus having a wireless communication block based on at least one of communication media of light, sound, and radio wave wherein, when communication with another device is performed, at least one of a window and an icon associated with the communication with said another device is displayed in a display area in the proximity of said wireless communication block.

9. The display apparatus according to claim 8 wherein, when at least one of said window and said icon is displayed in said display area, at least one of said window and said icon is displayed as if gradually moving to or departing from said wireless communication block.

10. The display apparatus according to claim 8 wherein said icon indicative of said device and/or an icon indicative of received data is displayed in said display area.

11. The display apparatus according to claim 8 wherein, an icon indicative of data to be transmitted is displayed and, when the transmission has been completed, said icon is turned off.

12. A display method using a display apparatus having a wireless communication block based on at least one of communication media of light, sound, and radio wave, comprising the steps of:
displaying a first icon in a display area in the proximity of a said wireless communication block when starting communication with another device; and
displaying a second icon which is different from said first icon when data are actually transferred with said another device.
